(19) United States
(12) Patent Application Publication
(10) Pub. No.: US 2019/0035038 A1
(43) Pub. Date: Jan. 31, 2019

(54) Revision Tracking and Storage for Contract Renewals

(71) Applicant: Adobe Systems Incorporated, San Jose, CA (US)

(72) Inventor: Benjamin D. Follis, London (GB)

(73) Assignee: Adobe Systems Incorporated, San Jose, CA (US)

(21) Appl. No.: 15/665,203

(22) Filed: Jul. 31, 2017

(51) Int. Cl. G06Q 50/18; G06F 17/24; G06F 3/0483; G06F 21/32; G06Q 10/06

(52) U.S. Cl. CPC G06Q 50/188; G06F 17/243; G06Q 10/06; G06F 21/32; G06F 3/0483

(57) ABSTRACT

A digital medium environment is described to improve tracking and storage of renewed contracts that contain revisions. In one example, a contract management system receives a revision to an existing contract and generates a revised version of the existing contract that visually distinguishes altered portions of the revised contract from unchanged portions. The contract management system additionally generates a memorandum of agreement that succinctly describes revisions to the existing contract for convenient reference. The contract management system transmits the memorandum of agreement to a signing party and for signature and return. Upon receiving the signed memorandum of agreement, the contract management system generates a signed version of the revised contract. The revised contract, existing contract, and memorandum of agreement are then associated and stored with one another for subsequent retrieval and revisions.

### BACKGROUND

Contracts are frequently used to memorialize terms of an agreement between parties. For example, a buyer may enter into a contractual relationship with a seller by accepting the seller's offer to purchase a certain number of items at a certain price. Contractual relationships are often renewed with only minor revisions to various contract terms. For instance, the purchase contract between the buyer and the seller may be renewed with amended terms to reflect an increase in price or a change in effective date. Because a contract often contain lengthy boilerplate language that remains unchanged as the contract is revised and renewed, a memorandum of agreement can be used to identify altered contract terms and incorporate by reference unchanged terms of a previously existing contract. A signing party can sign the memorandum of agreement to accept the altered contract terms, and thereby renew the contract.

However, conventional techniques that only communicate a memorandum of agreement in order to revise a contract fail to fully convey to a signing party the resulting effects on the underlying contract. For instance, conventional approaches to revising contracts by communicating only a memorandum of agreement fail to communicate implications of altered contract terms, other than an indication that a certain term is to be altered. For instance, using conventional approaches, a contract may undergo multiple revisions via the exchange of multiple memorandums of agreement. Because each memorandum of agreement is communicated independent of the original contract and any previous memorandums of agreement, conventional techniques fail to alert a singing party as to how terms of the original contract, much less terms changed by any intervening memorandums of agreement, will be altered.

Because conventional approaches communicate memorandums of agreement independent of the underlying contract, the underling contract and associated memorandums of agreement are often stored in disparate locations. Furthermore, conventional memorandums of agreement often only reference the underlying contract to which it pertains, without any indication as to where the underlying contract is stored, or if the memorandum of agreement modifies any previous memorandum of agreement. With the lack of any indication as to where a contract is stored, much less any option to directly access the contract from the memorandum of agreement, conventional techniques force a singing party to manually locate the contract in order to understand the implications of contract revisions.

This problem is further compounded with the failure of a storage location on which an original contract or previous memorandum of agreement is maintained. For example, in a conventional system where an original contract undergoes five rounds of revisions with five different memorandums of agreement, failure of a storage location that maintains any of the memorandums of agreement or original contract renders a current version of the contract invalid. The current version is rendered unenforceable because without a complete chain of memorandums of agreement back to the original contract, there is no way to track the changes of a current memorandum of agreement back to the original contract. Thus, conventional approaches require a signing party to manually attach an original contract and any previous memorandums of agreement to a current memorandum of agreement in order to fully communicate implications of a contract revision. Likewise, conventional techniques require signing parties to manually store original contracts with associated memorandums of agreement in a commonly accessible manner Thus, conventional approaches to contract revisions using memorandums of agreement remain cumbersome, tedious, and susceptible to creating unenforceable contracts by way of human error.

### SUMMARY

A digital medium environment is described to improve tracking and storage of contracts and contract revisions by a computing device. In one example, a contract management system is implemented at least partially in hardware of a computing device. The contract management system receives at least one revision for an existing contract, such as the replacement of an existing contract term with a new contract term, the addition of a contract field to an existing contract, or the removal of a contract field from an existing contract. The contract management system identifies the existing contract to which the at least one revision pertains and generates a revised contract by applying the at least one revision to the existing contract. In addition to generating the revised contract, the contract management system generates a memorandum of agreement, which describes in a succinct manner changes that were made in the existing contract to generate the revised contract.

The contract management system associates the existing contract, the revised contract, and the memorandum of agreement with one another and stores them together such that a comprehensive overview of contractual revisions over time can be accessed from a single location. The contract management system then transmits an unsigned version of the memorandum of agreement to a signing party in order for the signing party to sign and return the memorandum of agreement. The unsigned memorandum of agreement can be accompanied by the revised contract, which displays any revisions in a visually distinct manner from unchanged portions from the existing contract. Thus, a signing party can readily identify and comprehend the implications of contractual revisions. The contract management system then updates stored information to reflect acceptance by the signing party and maintains the existing contract, the revised contract, and the memorandum of agreement for future retrieval and revisions.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures may be indicative of one or more entities and thus reference may be made interchangeably to single or plural forms of the entities in the discussion.

FIG. 1 is an illustration of an environment in an example implementation that is operable to employ a contract management system for revision tracking and storage for contract renewals as described herein.

FIG. 2 depicts a system in an example implementation showing operation of the contract management system of FIG. 1 in greater detail.

FIG. 3 depicts an example implementation showing a user interface of a computing device in which a memorandum of agreement for contract renewals and a link to an associated contract can be implemented.

FIG. 4 depicts an example implementation showing a user interface of a computing device in which a revised contract, which visually indicates contract revisions based on the memorandum of agreement in the example user interface of FIG. 3, can be implemented.

FIG. 5 depicts an example implementation showing a user interface of a computing device in which a timeline of revised contracts and associated memorandums of agreement can be implemented.

FIG. 6 is a flow diagram depicting a procedure in an example implementation of revision tracking and storage for contract renewals.

FIG. 7 is a flow diagram depicting a procedure in an example implementation of revision tracking and storage for contract renewals.

FIG. 8 is a flow diagram depicting a procedure in an example implementation of revision tracking and storage for contract renewals.

FIG. 9 illustrates an example system including various components of an example device that can be implemented as any type of computing device as described and/or utilized with reference to FIGS. 1-8 to implement embodiments of the techniques described herein.

### DETAILED DESCRIPTION

Overview

Conventional systems for revising an existing contract by communicating a memorandum of agreement between signing parties only communicate a summary of specific terms to be altered. Rather than communicating the memorandum of agreement with the underlying contract or providing a way to access the underlying contract from the memorandum of agreement, conventional systems merely indicate that the underlying contract is incorporated by reference in the memorandum of agreement. Because conventional systems communicate memorandums of agreement separate from underlying contracts, conventional systems are unable to electronically track changes affected to a contract by a memorandum of agreement. For instance, conventional systems are unable to identify portions of an original contract modified by a memorandum of agreement. As such, conventional systems are unable to visually indicate to a signing party specific terms that are directly changed by a memorandum of agreement, much less visually indicate contract terms that are indirectly changed by a memorandum of agreement. Thus, conventional systems are unable to alert signing parties to portions of a contract that are altered by a memorandum of agreement, and fail to communicate the effects of applying a memorandum of agreement to a contract.

Similarly, because memorandums of agreement and contracts are communicated independent of one another, conventional approaches to contract revisions lack a central storage location for associating and accessing contract and associated memorandums of agreement. Due to this lack of a central storage location, conventional approaches do not provide a mechanism for accessing an original contract from a memorandum of agreement, or vice versa.

Additionally, in situations where a contract has undergone multiple revisions via multiple memorandums of agreement, conventional systems may only return a subset of the memorandums of agreement in response to a search for the contract and associated revisions. As such, conventional systems fail to provide a comprehensive overview of contractual revisions represented by each and every associated memorandum of agreement.

Conventional approaches thus rely on a signing party to manually generate a revised contract and are unable to electronically track changes to an original contract indicated in a memorandum of agreement, much less automatically generate a revised contract from the memorandum of agreement. Thus, conventional techniques for contract revisions remain cumbersome, tedious, and susceptible to creating unenforceable contracts by way of human error.

Accordingly, revision tracking and storage techniques and systems for contract renewals are described. To ensure that contract revisions are indelibly connected to an original contract, the techniques and systems described herein automatically associate a contract revision with the original contract. In one example implementation, this is accomplished by designating a single storage location to host the original contract and any subsequent revisions. Upon receiving a revision to an original contract, the system described herein automatically identifies a portion of the contract to which the revision pertains and generates both a memorandum of agreement and a revised contract. Both the memorandum of agreement and revised contract are automatically generated in a manner that visually distinguishes altered portions of the original contract, thereby reducing a probability that a signing party will inadvertently miss a revised contract portion upon review.

By indelibly associating the original contract, contract revision, memorandum of agreement, and revised contract with one another and storing the associated documents in a common location, the techniques described herein enable search capability and navigation among the associated documents. For instance, upon receiving an input search for any single document, the systems and techniques described herein is able to leverage the automatic document association and common storage location to identify and return as an output all associated documents. Among other benefits, such association and search functionality reduces time for searching related documents, while simultaneously creating a navigable timeline of revisions originating from an existing contract.

The systems and techniques described herein automatically generates the memorandum of agreement to succinctly include a description of any revision to the underlying contract, while also including information useable by a computing device to identify both the underling contract, any previous revisions to the underlying contract, and the parties to the underlying contract. Additionally, the systems and techniques described herein identifies altered portions of the underlying contract by mapping the contract revision to portions of the underlying contract.

From this identification, the systems and techniques described herein automatically generate a revised contract and output visual enhancements in portions of the revised contract that are changed from the underlying contract. For instance, the systems and techniques described herein configure the text of revised portions of an underlying contract visually for display in a manner that is distinguishable from unchanged portions of the underlying contract. In at least one implementation, altered terms of a revised contract are displayed in a different color or different font style in comparison to unaltered terms of the revised contract. Similarly, portions of an existing contract that are removed or otherwise not included in the revised contract can be visually indicated in strikethrough to show that the removed portions are no longer part of an agreement.

After automatically generating the memorandum of agreement and the revised contract, the systems and techniques described herein automatically communicate the existing contract, the memorandum of agreement, and the revised contract as associated documents to a party to the contract. The systems and techniques described herein are configured to visually present the associated documents to a signing party in a user interface configured to enable navigation among the associated documents. The user interface is further configured to enable a signing party to review and reject or accept both the automatically generated memorandum of agreement and automatically generated revised contract.

Upon receiving an indication that the signing party has either accepted or rejected the memorandum of agreement and revised contract, the systems and techniques described herein stores the memorandum of agreement and the revised contract for future review, regardless of whether the revised contract was accepted or rejected. In this manner, the systems and techniques described herein create a comprehensive timeline of all proposed and accepted changes to an underlying contract, such that the timeline can be easily accessed for future viewing and revisions.

For instance, the systems and techniques described herein are configured to receive subsequent contract revisions to the revised contract and automatically generate a new memorandum of agreement and a new revised contract, which includes both revisions from the original memorandum of agreement and the new memorandum of agreement. Thus, the systems and techniques described herein are configured to automatically generate, associate, and store copies of each iteration as a contract undergoes revisions, along with information that describes exactly what the contractual parties viewed and agreed upon when entering into a contractual relationship.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

Terms

The term “contract” refers to a written agreement between two or more individuals that is intended to be enforceable by law. As described herein, a contract is presumed to be a structured document having named fields included in metadata of the structured document, along with field values for each of the named fields. For example, a contract may have named fields such as a date of effect field, a price field, a quantity field, and so on. Field values for the respective fields may include a Feb. 1, 2017 value for the date of effect field, a $12.00 value for the price field, a 500 value for the quantity field, and so on. As described herein, a contract field may include any suitable portion of a contract, such as an addendum, an appendix, a section, a paragraph, a sentence, a word, a character, a digit, and so on.

The term “contract revision” refers to an instruction to alter a field value of an existing contract. For example, a contract revision may include a specified contract field of an existing contract and a replacement value to be used in the specified contract field of the existing contract. Alternatively or additionally, a contract revision may specify a contract field to add to an existing contract, along with a field value for the added field. Additionally or alternatively, a contract revision may specify a contract field to remove from an existing contract.

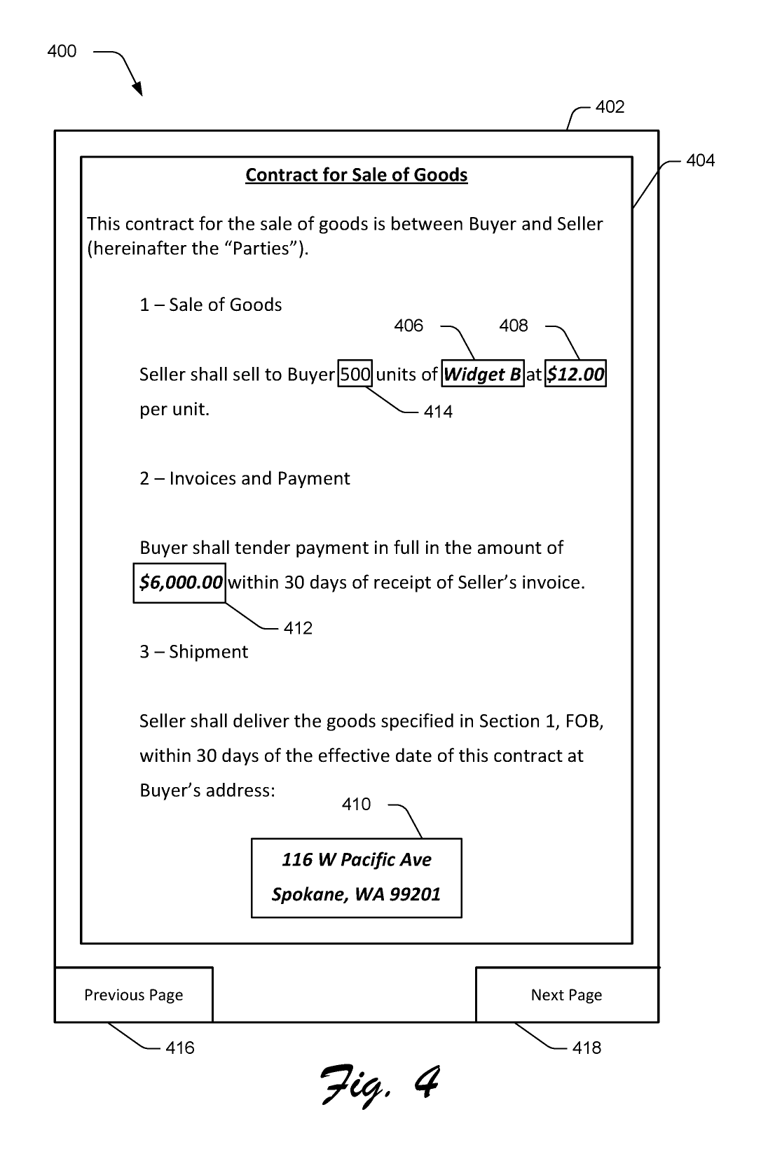

The term “revised contract” refers to a contract generated from an existing contract by applying instructions of one or more contract revisions to the existing contract. An example of a revised contract is illustrated and described with reference to FIG. 4.

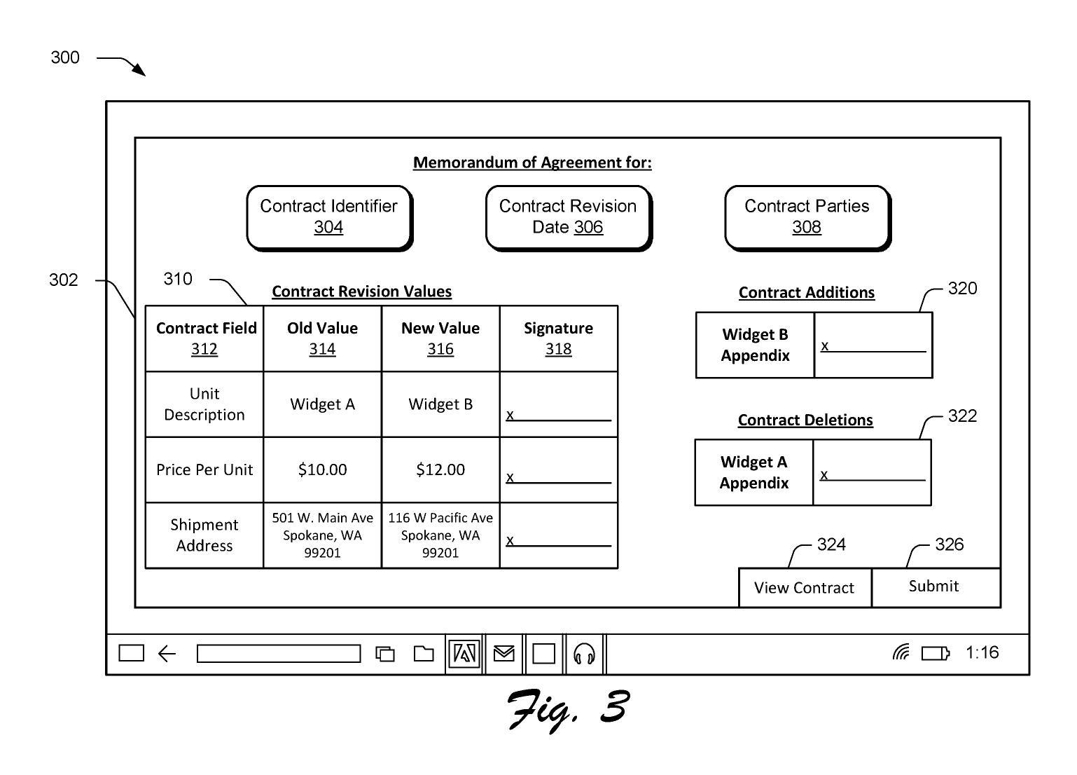

The term “memorandum of agreement” refers to a summary that describes at least one change made to an existing contract as specified by a contract revision and includes at least one portion for entry of a signature to accept the at least one change. A memorandum of agreement additionally identifies an existing contract with which it is associated. An example memorandum of agreement for a contract revision that specifies a replacement value for a specified field of an existing contract and a field to be added to the existing contract lists the alterations to the existing contract accompanied by portions to accept the replacement value and the field to be added, such as the memorandum of agreement illustrated and described with reference to FIG. 3.

The term “user input” refers to any command initiated by a user to control functionality of, or interact with, a computing device. Examples of user inputs are commands received via an input device such as a touchscreen, a mouse, a keyboard, a microphone, and so on.

The term “user interface” refers to the means by which a user and a computing device interact through implementation of display devices such as computer screens, televisions, projectors, wearable light guides, and so on.

Example Environment

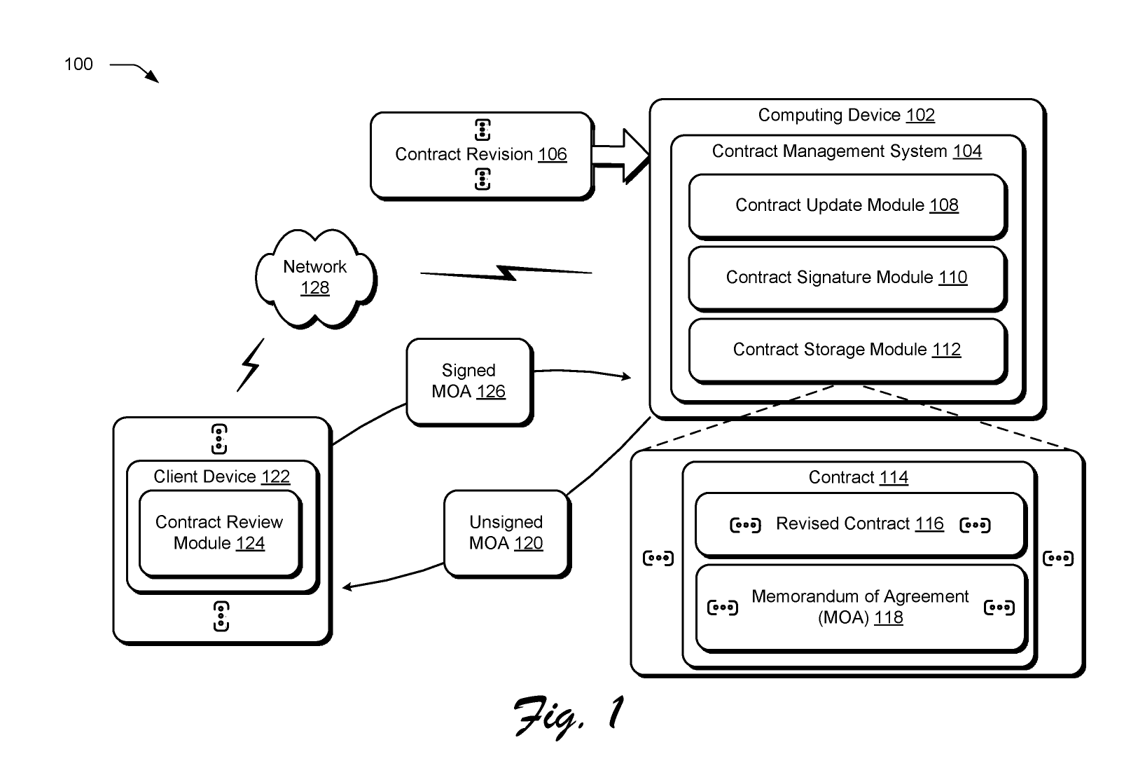

FIG. 1 is an illustration of an environment 100 in an example implementation that is operable to employ a contract management system for revision tracking and storage for contract renewals using the techniques described herein. The illustrated environment 100 includes a computing device 102, which may be configured in a variety of ways.

The computing device 102, for instance, may be configured as a desktop computer, a laptop computer, a mobile device (e.g., assuming a handheld configuration such as a tablet or mobile phone as illustrated), and so forth. Thus, the computing device 102 may range from full resource devices with substantial memory and processor resources (e.g., personal computers, game consoles) to a low-resource device with limited memory and/or processing resources (e.g., mobile devices). Additionally, although a single computing device 102 is shown, the computing device 102 may be representative of a plurality of different devices, such as multiple servers utilized by a business.

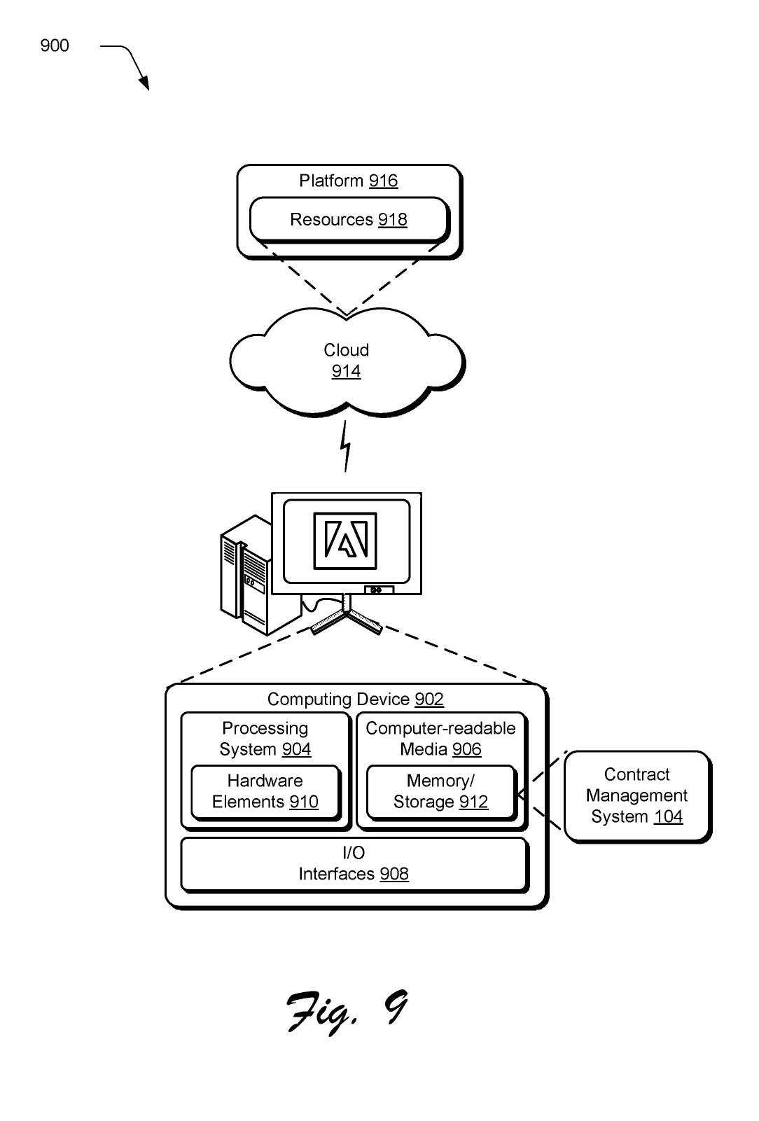

The computing device 102 is illustrated as including a contract management system 104. The contract management system 104 is implemented at least partially in hardware of the computing device 102 (e.g., using a processing system and computer-readable storage media) to generate a revised contract and a memorandum of agreement from a contract revision. The contract management system 104 is additionally configured to obtain a signature for the revised contract and store an original contract, the revised contract, and the memorandum of agreement for subsequent retrieval. Although illustrated as implemented locally at the computing device 102, functionality of the contract management system 104 may also be implemented as whole or part via functionality available via a network, such as part of a web service or “in the cloud” as further described in relation to FIG. 9.

The contract management system 104 is configured to perform the techniques described herein upon receiving at least one contract revision 106 for an existing contract. In accordance with one or more implementations, the at least one contract revision 106 is received via user input at the computing device 102. Alternatively, the at least one contract revision 106 is received from a computing device remote to the computing device 102. The contract revision 106 is received by the contract management system 104 with information describing an existing contract to which the contract revision 106 pertains. For instance, information describing the existing contract can include a contract date, a list of two or more parties to which the contract pertains, a contract identifier such as a title, serial number, and so on, or combinations thereof.

In addition to information describing the contract to which the contract revision 106 pertains, the contract revision 106 identifies a field of an existing contract along with a replacement field value for the identified field. As described herein, a contract field includes any portion of a contract, such as a section, an appendix, a word, a digit, a character, and so forth. Thus, the contract revision 106 can specify a change to be made to any portion of a contract. Alternatively or additionally, the contract revision 106 can specify fields to add to, or remove from, an existing contract.

An example of functionality incorporated by the contract management system 104 to perform revision tracking and storage for contract renewals is illustrated as contract update module 108, contract signature module 110, and contract storage module 112. The contract update module 108, contract signature module 110, and contract storage module 112 are implemented at least partially in hardware (e.g., processing system and computer-readable storage media) of the computing device 102. The contract update module 108, for instance, monitors for receipt of a contract revision 106 at the computing device 102. Upon receipt of the contract revision 106, the contract update module 108 communicates with contract storage module 112 to identify a contract 114 to which the contract revision 106 pertains. For example, the contract update module 108 transmits a contract identifier included in the contract revision 106 that is useable by the contract storage module 112 to identify an existing contract 114 corresponding to the contract identifier.

In accordance with one or more implementations, the contract storage module 112 includes a repository of stored contracts 114. For instance, contract storage module 112 may be configured as a structured set of data that organizes contracts based on any suitable metric, such as based on contract identifiers, parties to a contract, contract titles, contract dates, and so on. For each stored contract 114, the contract storage module 112 is configured to store at least one revised contract 116 and at least one memorandum of agreement (MOA) 118 for the stored contract 114. Accordingly, the contract storage module 112 is configured to centrally store an original contract in an indelible manner with any associated contract revisions, whether proposed or enacted. By associating the contract 114 with any historical revisions, represented by revised contract 116 and the MOA 118, the contract storage module enables access to an entire revision history of a contract 114 from a single location.

After the contract storage module 112 identifies a contract 114 to which the received contract revision 106 pertains, the contract storage module 112 communicates a current version of the contract 114 to the contract update module 108. The contract update module 108 then applies the contract revision 106 to the contract 114 to generate a revised contract 116. In addition to generating the revised contract 116, the contract update module 108 is configured to generate a memorandum of agreement 118, which describes what changes were made from the contract 114 to generate revised contract 116.

In accordance with one or more implementations, the contract update module is configured to visually distinguish at least one portion of the revised contract 116 that is different from a corresponding portion in the contract 114. Accordingly, the revised contract 116 readily identifies what portions of the revised contract 116 were changed through the application of the contract revision 106 to the contract 114. The revised contract 116 and the memorandum of agreement 118 are then associated with the original contract 114 and stored together in the contract storage module 112. An example revised contract and an example memorandum of agreement are described in further detail below.

After the revised contract 116 and the memorandum of agreement 118 are stored in the contract storage module 112, the contract signature module 110 transmits an unsigned version of the memorandum of agreement, illustrated as unsigned MOA 120 of FIG. 1, to at least one signing party for signature. In accordance with one or more implementations, the signing party is identified in either the contract revision 106, in the original contract 114, or in a revised version of the original contract 116. The contract signature module 110 is configured to identify the at least one signing party and transmit the unsigned MOA 120 to the identified signing party for signature. In the illustrated example of FIG. 1, the unsigned MOA 120 is transmitted to client device 122 for signature.

Client device 122 includes a contract review module 124 that is configured to display the unsigned MOA 120 for review and approval. As described herein, the unsigned MOA 120 describes all changes in the revised contract 116 that result from applying the at least one contract revision 106 to the original contract 114. An example user interface provided by the contract review module 124 and corresponding display of the unsigned MOA 120 are described in further detail below. In accordance with one or more implementations, the unsigned MOA 120 includes a prompt for a signature adjacent to each revision, addition, and/or deletion caused by the at least one contract revision 106. Thus, the unsigned MOA 120 provides a comprehensive overview of any changes that are made to an existing contract. In accordance with one or more implementations, the unsigned MOA 120 may be transmitted to the client device 122 along with at least one of the original contract 114 or the revised contract 116. As such, the contract review module 124 is configured to provide all information describing a contract's history and associated changes without requiring a manual search for different documents in different storage locations.

Assuming that the signing party accepts the contract revisions described in the unsigned MOA 120, the signing party enters signatures via the contract review module 124 as prompted by the unsigned MOA 120. Upon receiving a signature to the unsigned MOA 120, the contract review module 124 returns a signed MOA 126 to the contract management system 104. Transmission of the unsigned MOA 120 and the signed MOA 126 between the computing device 102 and the client device 122 may be accomplished through any suitable communication mechanism, such as via network 128, which is illustrated as communicatively coupling the computing device 102 and the client device 122. Upon receipt of the signed MOA 126, the contract storage module 112 updates a corresponding memorandum of agreement 118 to indicate acceptance of the contract revision 106.

In accordance with one or more implementations, the contract signature module 110 is configured to insert a signature from the signed MOA 126 into the revised contract 116. Thus, the contract management system 104 is configured to update information stored within the contract storage module 112 to indicate whether the proposed contract revision 106 has been accepted by all parties to the contract. As such, the contract management system 104 provides a central repository of information describing historical changes to a contract 114, regardless of a number of revised versions of the contract that may have been generated over time. Similarly, in the absence of receiving a signed MOA 126, the contract management system 104 is configured to store information describing a proposed contract revision 106 that did not take effect. Example operations of the contract management system is described as follows and shown in corresponding figures.

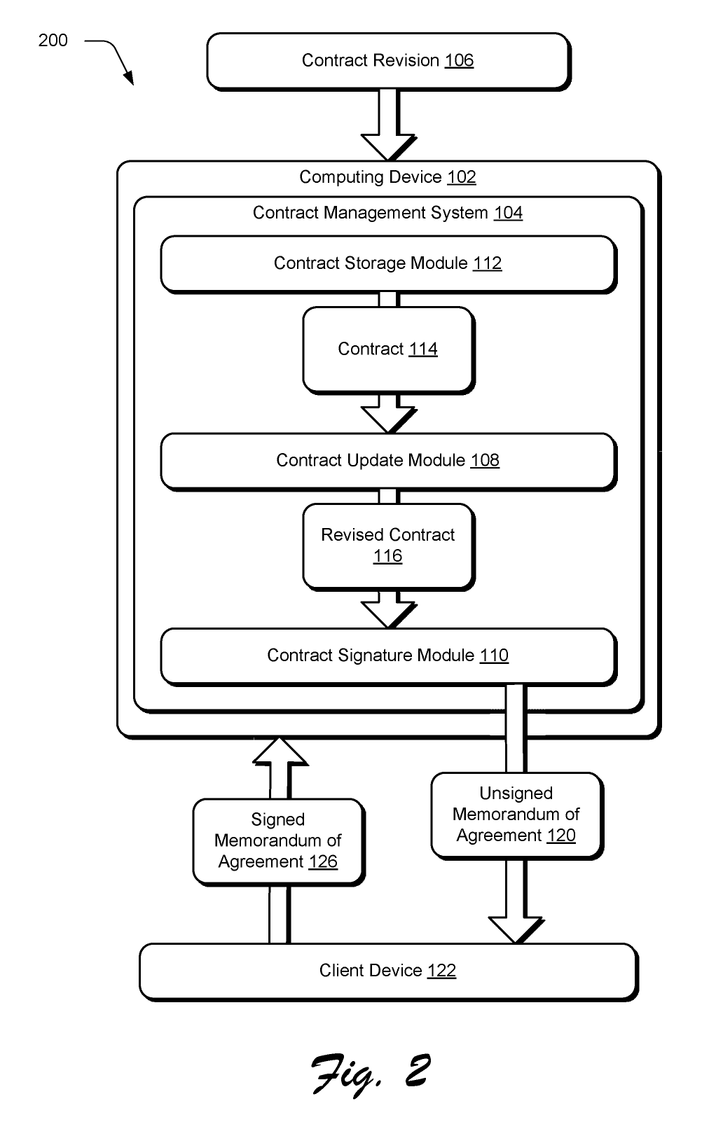

FIG. 2 depicts a system 200 in an example implementation showing operation of the contract management system 104 of FIG. 1 in greater detail. To begin, computing device 102 receives a contract revision 106. As described herein, the contract revision 106 specifies at least one of a contract revision value for an existing contract field, a contract addition field for the existing contract, or a field to be deleted from the existing contract. For instance, the computing device 102 receives contract revision 106 via input at an input device of the computing device 102. Alternatively, contract revision 106 is received by computing device from a different computing device implemented remotely from computing device 102, such as via network 128.

The contract revision 106 additionally includes information useable to identify the existing contract to which the contract revision 106 pertains. The information useable to identify the existing contract can be any suitable type of information. For example, the information may be an identifier of the existing contract, such as a contract title, contract serial number, and so forth. Additionally or alternatively, the information useable to identify the existing contract can include an effective date of the contract or most recent revision date of the contract, coupled with information identifying two parties to be bound by the existing contract. Thus, the computing device 102 receives information describing an existing contract, as well as information describing at least one identified field and data to be included in the at least one identified field for generating a revised contract.

Including information useable to identify the existing contract, a contract revision value for an existing contract field, a contract addition field for the existing contract, or a field to be deleted from the existing contract in the contract revision 106 may be performed in any suitable manner. For instance, the information included in contract revision 106 may be received via a custom user interface presented at computing device 102 that enables selection or specification of at least one section of an existing contract to replace. This selection or specification can be performed through inclusion of metadata in the contract revision 106 that identifies one or more named fields in an existing contract as well as replacement values for the named fields. Additionally or alternatively, the custom user interface may enable use of a search and replace value, or any other reasonable method of designating a portion of an existing contract along with replacement values for the designated portion. For example, the contract revision 106 may indicate supplemental content, such as an appendix or attached file, to be added to or removed from an existing contract.

In some embodiments, a plain language description can be used to generate the contract revision 106. For example, natural language processing (NLP) may be used to translate a plain language description and generate the contract revision 106. A contract revision 106 generated using NLP can be received and displayed by the computing device 102. In this manner, the computing device 102 can display the contract revision 106 for accurate verification of any contract revision 106 generated using NPL. In this manner, the displayed contract revision 106 can be modified to correct any errors that may have arisen from NLP translation. Thus, contract revision 106 includes information necessary to generate a revised contract from an existing contract.

Upon receiving the contract revision 106, the computing device 102 communicates the contract revision 106 to the contract management system 104. With the information useable to identify the existing contract specified by contract revision 106, the contract management system 104 locates and retrieves the existing contract 114 from contract storage module 112. In some implementations, the contract storage module 112 is configured as a searchable database, such that a plurality of stored existing contracts are easily searchable and retrievable based on information included in the contract revision 106.

Additionally or alternatively, although not illustrated in FIG. 2, there may be scenarios where the contract storage module 112 does not include an existing contract 114 to which the contract revision 106 pertains. In these scenarios, the contract management system 104 is configured to request a copy of the existing contract 114 from the drafting party that provided contract revision 106, such as from computing device 102. Additionally or alternatively, the contract management system 104 can request a copy of the existing contract 114 from a party to the existing contract 114 other than the drafting party, such as from client device 122. After obtaining the contract 114, the contract storage module 112 passes the contract 114 and the contract revision 106 to the contract update module 108.

Upon receiving the contract 114 and the contract revision 106, the contract update module 108 generates a revised contract 116 by applying the contract revision 106 to the contract 114. In accordance with one or more implementations, generating the revised contract 116 includes replacing an existing field value of a named field in contract 114 with a new field value, adding a field to contract 114, deleting a field from contract 114, or combinations thereof. Although only illustrated as including a single contract revision 106, the contract update module 108 is configured to process and apply any number of contract revisions 106 to the contract 114 in order to generate the revised contract 116.

In some implementations, supplemental content, such as an appendix, is to be added to the contract 114. To do so, the contract management system 104 retrieves a copy of the supplemental amendment, associates the supplemental amendment with the contract 114 and the revised contract 116, and stores the supplemental content in contract storage module 112. Thus, contract management system 104 is configured to associate all relevant information describing historical revisions of a contract and store these revisions in a manner that can be accessed simultaneously.

In addition to revising the contract 114 as specified by the contract revision 106, the contract update module 108 is configured to propagate changes throughout revised contract 116 to update any computed values in the revised contract 116 that may change as a result of altered field values. For instance, if the contract revision 106 indicates that the price of goods for a contract concerning the sale of goods has changed, the contract update module 108 is configured to compute and update a table of payment and/or an overall price computed from quantity in the revised contract 116.

After generating the revised contract 116, the contract update module 108 communicates the revised contract 116 to the contract signature module 110. Contract signature module 110 generates an unsigned memorandum of agreement 120 from the revised contract 116. The unsinged memorandum of agreement 120 summarizes and describes any alterations made to the contract 114 in order to generate the revised contract 116. An example of an unsigned memorandum of agreement generated from the revised contract 116 is illustrated in FIG. 3 and described in further detail below. In addition to including a description of revisions made to existing contract 114 in the generation of revised contract 116, the unsigned memorandum of agreement 120 includes at least one field prompting a signing party's signature to accept proposed contractual changes. The contract signature module associates the unsigned memorandum of agreement 120 with both the revised contract 116 and the contract 114, and stores the unsigned memorandum of agreement 120 in contract storage module 112.

The contract signature module 110 then communicates the unsigned memorandum of agreement 120 to a signing party, such as to client device 122, in order for the signing party to review and approve proposed changes included in contract revision 106. In some implementations, because the unsigned memorandum of agreement 120 is associated with both the existing contract 114 and the revised contract 116, communicating the unsigned memorandum of agreement 120 to the client device 122 also communicates the contract 114 and the revised contract 116. Accordingly, client device 122 is provided with all necessary information to readily identify the implications of contract revision 106 as applied to contract 114.

Assuming that the signing party accepts the proposed changes included in contract revision 106, the client device 122 enters a signature to the unsigned memorandum of agreement 120. This signature is inserted to generate a signed memorandum of agreement 126. The signed memorandum of agreement 126 is then communicated back to the computing device implementing the contract management system 104. Upon receipt of the signed memorandum of agreement 126, the contract management system 104 updates a status of the unsigned memorandum of agreement 120 to reflect has acceptance of the revised contract 116. In accordance with one or more implementations, contract signature module 110 is configured to extract a signature from the signed memorandum of agreement 126 and insert the extracted signature into the revised contract 116. In this manner, the contract management system 104 provides a convenient approach for a signing party to review, comprehend, and accept proposed changes to an existing contract without having to read through lengthy portions that remain unchanged from an existing contract.

Furthermore, although the operations of contract management system 104 have been described with respect to a single signing party, the contract management system can send unsinged memorandums of agreement 120 to multiple signing parties. A number of signing parties to which the unsigned memorandum of agreement is sent depends on a number of parties to the revised contract 116.

Alternatively, in the absence of receiving a signed memorandum of agreement 126, contract management system 104 does not update a status of the unsigned memorandum of agreement 120 stored in the contract storage module 112. Accordingly, the contract management system 104 is configured to store a history of all contract revisions 106, regardless of whether proposed contract revisions 106 are accepted or rejected.

Using the techniques described herein, contract 114 is associated and stored with revised contract 116, contract revision 106, unsigned memorandum of agreement 120, and/or signed memorandum of agreement 126 as associated documents. Accordingly, searching for one of the associated documents produces results including all of the associated documents. This is particularly useful when a party to a contract needs to retrieve a complete history of a contractual relationship with only limited information, such as a single unsigned memorandum of agreement.

FIG. 3 depicts an example implementation 300 showing a user interface of a computing device in which a memorandum of agreement for contract renewals and a link to an associated contract can be implemented using the revision tracking and storage techniques for contract renewals describe herein. In the illustrated example, the unsigned memorandum of agreement 302 includes a contract identifier 304 to which the unsigned memorandum of agreement pertains, a contract revision date 306, and at least two contract parties 308 to the revised contract. The contract identifier 304 includes a display of any suitable information useable to identify a contract, such as a contract title, a contract serial number, and so on. The contract revision date 306 can include either a date of the proposed contract revision to which the memorandum of agreement 302 pertains, a proposed effective date for the revised contract, or combinations thereof. Contract parties 308 includes a listing of all parties that are to be bound under the revised contract.

In accordance with some implementations information specified in contract parties 308 is used to restrict access to the unsigned memorandum of agreement 302, along with any other associated documents. For instance, the associated documents may include a contract 114, a revised contract 116, another unsigned memorandum of agreement 120, and/or a signed memorandum of agreement 126, as illustrated in FIGS. 1 and 2. Accordingly, the contract management system 104 is configured to protect the privacy of contract parties 308 by restricting access to users who do not provide necessary authentication credentials. For example, access to the contract 114 and associated documents is only permitted with authentication credentials of the contract parties 308. In accordance with one or more implementations, authentication credentials are stored at the contract management system 104, such as in contract storage module 112.

In order to clearly inform a signing party of any and all proposed revisions to an existing contract, the unsigned memorandum of agreement includes a table of contract revision values 310. The table of contract revision values 310 identifies a named field in an existing contract, an old value for the named field, and a new value for the existing field. The table of contract revision values 310 additionally includes a portion that prompts a signing user to enter a signature. For example, the table of contract revision values 310 illustrated in FIG. 3 includes a column of named contract fields 312, a column of old values 314, a column of new values 316, and a column of signature prompts 318. Specifically, the table of contract revision values 310 includes the following information:

| Contract Field | Old Value | New Value | Signature |
|---|---|---|---|
| 312 | 314 | 316 | 318 |
| Unit Description | Widget A | Widget B | X |
| Price Per Unit | $10.00 | $12.00 | X |
| Shipment Address | 501 W. Main Ave | 116 W Pacific Ave | X |
| | Spokane, WA | Spokane, WA | |
| | 99201 | 99201 | |

Thus, the table of contract revision values 310 enables convenient identification of all proposed changes to existing contract fields. For example, the unsigned memorandum of agreement 302 clearly specifies that a proposed revision to an existing contract for the sale of “Widget A” units is to be revised to pertain to the sale of “Widget B” units. Thus, any contract field defined as a “Unit Description” in an existing contract will be revised to recite “Widget B” instead of “Widget A”. Similarly, the table of contract revision values 310 clearly indicates that the proposed price per unit of an existing contract will be changed from $10.00 per unit to $12.00 per unit. Thus, any contract field defined as “Price Per Unit” in an existing contract will be revised to recite “$12.00” instead of “$10.00”. Finally, the table of contract revision values 310 indicates a change in shipment address under the revised contract. Thus, a contract field defined as “Shipment Address” in an existing contract will be revised to recite “116 W. Pacific Ave, Spokane, Wash., 99201” instead of “501 W. Main Ave, Spokane, Wash., 99201”.

Accordingly, the table of contract revision values 310 provides a signing party with a succinct and easily identifiable overview of proposed changes to a contract, such as changes indicated by contract revision 106 of FIGS. 1 and 2. In this manner, signature column 318 is configured to receive a signature to indicate acceptance of proposed contractual term changes. In the illustrated example 300, signature column 318 includes three portions, one for each proposed contract field revision in column 312.

The unsigned memorandum of agreement 302 thus enables acceptance of some proposed changes and rejection of others, acceptance of all proposed changes, or rejection of all proposed changes. Accordingly, the unsigned memorandum of agreement 302 enables negotiating terms of a contract by easily identifying proposed revisions that are accepted and proposed revisions that are rejected. Depending on the severability of the revised contract pertaining to the unsigned memorandum of agreement 302, acceptance of only some of the proposed contract revision values can result in rejecting the entire contract. Accordingly, although not illustrated, the unsinged memorandum of agreement 302 can include a visual indication that certain contract revision values must be accepted in order to avoid rejecting the entire revised contract.

In addition, the unsinged memorandum of agreement 302 is illustrated as including contract additions 320. Contract additions 320 specify at least one field to be added to a revised contract, such as revised contract 116, that were not included in an existing contract from which the revised contract is generated. In the illustrated example 300, contract additions 320 include a selectable link to view “Widget B Appendix”, which is proposed for addition to the revised contract. Contract additions 320 additionally include a portion in which a signing party can enter a signature to accept the addition of the “Widget B Appendix”. In accordance with one or more implementations, the unsigned memorandum of agreement 302 may prevent entry of a signature in contract additions 320 unless the selectable link to view “Widget B Appendix” has been selected. In this manner, the unsigned memorandum of agreement 302 is configured to ensure that a signing party fully reviews proposed changes before they are accepted.

Similarly, the unsinged memorandum of agreement 302 is illustrated as including contract deletions 322. Contract deletions 322 specify at least one field of an existing contract, such as contract 114, to be removed in order to generate a revised contract, such as revised contract 116. In the illustrated example 300, contract deletions 322 include a selectable link to view “Widget A Appendix”, which is proposed for deletion from the existing contract (i.e., proposed not to be incorporated into the revised contract). Contract deletions 322 additionally include a portion for entry of a signature to accept the deletion of the “Widget A Appendix” from the existing contract. In accordance with one or more implementations, the unsigned memorandum of agreement 302 prevents entry of a signature in contract deletions 322 unless the selectable link to view “Widget A Appendix” has been selected.

Alternatively, or in addition to including multiple portions for signatures, the unsigned memorandum of agreement 302 may include a single signature portion to accept all changes. For example, the unsigned memorandum of agreement 302 may include a single signature portion for a signing party to accept all changes described in the table of contract revision values 310, the contract additions 320, and the contract deletions 322. In this manner, the unsigned memorandum of agreement 302 is configured to ensure complete review of proposed changes before they are accepted.

In accordance with one or more implementations, unsigned memorandum of agreement 302 additionally includes selectable icons 324 and 326. Selectable icon 324 is illustrated as providing a link to view the revised contract. An example revised contract is illustrated in FIG. 4 and described in further detail below. Additionally, selectable icon 326 includes an option to “Submit” the memorandum of agreement 302 to a contract management system. For instance, the memorandum of agreement 302 may be submitted after signatures have been entered indicating acceptance of the revisions indicated in the table of contract revision values 310, the contract additions 320, and the contract deletions 322. When the “Submit” icon 326 is selected, the memorandum of agreement is communicated back to the contract management system.

FIG. 4 depicts an example implementation 400 showing a user interface 402 of a computing device in which a revised contract 404, which visually indicates contract revisions from a memorandum of agreement, such as the memorandum of agreement in the example user interface of FIG. 3. In accordance with one or more implementations, the user interface 402 is displayed on a computing device that displayed the example user interface of FIG. 3, in response to selection of the “View Contract” icon 324.

In the illustrated example 400, the user interface 402 includes display of a revised contract 404. The revised contract 404 includes fields 406, 408, and 410 that include revised field values from an existing contract. For example, fields 406, 408, and 410 display information that was altered from an original contract, such as contract 114, to generate a revised contract, such as revised contract 116. The fields 406, 408, and 410 are displayed in a manner that is visually distinguished from portions of the revised contract 116 that remain unchanged from the contract 114. For instance, in the illustrated example 400, field values of fields 406, 408, and 410 are displayed in bold and italicized font, so that a signing party can readily identify which portions of the revised contract 404 have been altered.

Although illustrated and described as being visually distinguished from other portions of the contract by being bold and italicized, field values of fields 406, 408, and 410 can be visually distinguished in any suitable manner. For example, visually distinguishing field values can include displaying field values in a different color font from a remainder of the revised contract 404, a different font size from a remainder of the revised contract 404, and so on. Further, the contract management system 104 can visually distinguish altered field values in an interactive manner that visually displays an original field value that has been revised by an altered field value. For instance, in response to receiving input at one of fields 406, 408, or 410, a display of the corresponding field value can be altered to display the field value of the previously existing contract. For example, in response to receiving user input that clicks on or hovers over field 406, a display of field 406 is changed to a previous field value, such as to display “Widget A” in a manner that is visually similar to other unchanged portions in the revised contract.

Thus, the revised contract 404 visually identifies that a unit description for the revised contract is changed to “Widget B”, as specified in field 406. Similarly, a price per unit is visually identified as changed to “$12.00”, as specified in field 408, and a shipment address is visually identified as changed to “116 W Pacific Ave, Spokane, Wash. 99201”, as specified in field 410. Accordingly, the revised contract 404 visually depicts contract revisions noted in a memorandum of agreement, such as in the unsigned memorandum of agreement 302 of FIG. 3.

Additionally, the revised contract 404 is illustrated as including computed field 412. Computed field 412 represents an overall value of the contract, as computed from field values indicating a number of units to be sold and a price per unit under the contract. For instance, the computed field 412 is computed by multiplying a value of field 414, indicating a number of Widget B units to be sold under the contract, with a value of field 408, indicating the price per unit of Widget B. Because the number of units to be sold under the contract indicated at field 414 is not visually emphasized from a remainder of the revised contract 404, the number of units to be sold remains unchanged from an existing contract, such as contract 114 of FIG. 1. However, because the price per unit of Widget B is revised to $12.00, as indicated in field 408, a resulting overall value of the revised contract 404 must also be revised.

As illustrated in example 400, a value of field 412 is computed from the values of fields 408 and 414 and visually distinguished from unchanged portions of the revised contract 404 to clarify that the overall payment due under the contract is revised to “$6,000.00”. Accordingly, by computing field value changes that result from other contract revisions, the contract management system is configured to visually indicate changed information in a revised contract that otherwise may not be included in an associated memorandum of agreement.

Thus, the techniques described herein visually indicate revised contract fields in a manner that enables a signing party to readily comprehend all contractual revisions and the implications thereof. The illustrated user interface 402 additionally includes selectable icon 416 labeled “Previous Page” and selectable icon 418 labeled “Next Page” for navigation through the revised contract 404. In accordance with one or more implementations, display of the user interface 402 is performed by a contract review module, such as contract review module 124 of client device 122, as illustrated in FIG. 1.

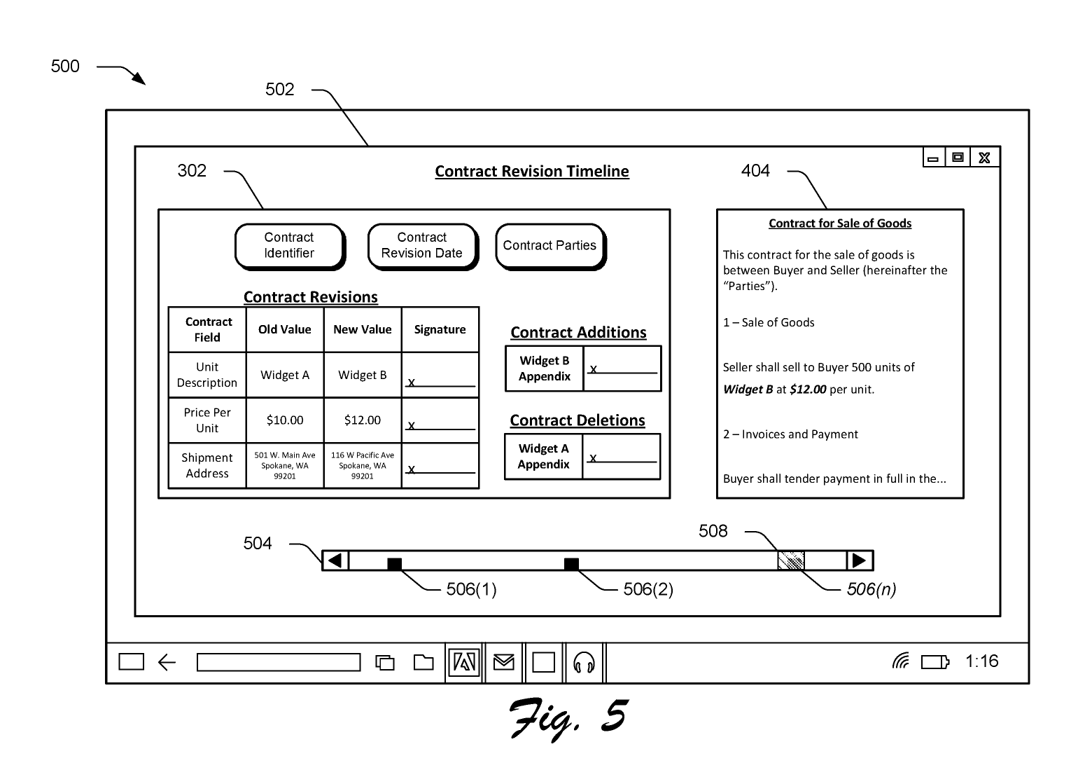

FIG. 5 depicts an example implementation 500 in which a user interface 502 of a contract revision timeline is displayed on a computing device. For example, the user interface 502 can be displayed on a display device of computing device 102 and/or client device 122, as illustrated in FIG. 1. In the illustrated example, the contract revision timeline user interface 502 includes a navigable scrollbar 504 that can be used to navigate among historical revisions of a contract, indicated by blocks 506(1), 506(2), . . . , 506(n). In the illustrated example, a position indicator 508 of the scrollbar 504 coincides with block 506(n), which is the rightmost block on the scrollbar 504 and thus indicates a most recent version of a revised contract. The contract revision timeline user interface 502 includes a display of an unsigned memorandum of agreement 302 and a corresponding revised contract 404, similar to those illustrated in FIGS. 3 and 4.

Conversely, block 506(1) is the leftmost block on the scrollbar 504, and thus represents an original contract. Accordingly, when the position indicator 508 is located as coinciding with block 506(1), the contract revision timeline user interface 502 displays an original contract without amendments or revisions, such as contract 114 of FIG. 1. Similarly, when the position indicator 508 is located as coinciding with block 506(2), the contract revision timeline user interface 502 displays a revised version of the original contract. The revised version of the original contract is displayed with a corresponding memorandum of agreement upon which the unsigned memorandum of agreement 302 is further applied to generate revised contract 404.

Thus, the contract management system 104 is able to roll up revisions made through multiple memorandums of agreement while maintaining a clear record of how a particular contract has evolved over time. Importantly, the contract revision timeline user interface 502 displays the unsigned memorandum of agreement 302 and the revised contract 404 in a manner that is identical to a display of the same as viewed by a signing party before signing.

Accordingly, the techniques described herein maintain a clear record of evidence describing how parties to a contract were specifically put on notice as to proposed contract revisions. Similarly, upon receiving a signed version of the unsigned memorandum of agreement 302, the contract storage module 112 is updated, such that the contract revision timeline user interface 502 displays the signed version of the memorandum of agreement. This contract revision timeline user interface 502 is available for viewing by any authorized party having access to the original contract, a revised version of the original contract, or a memorandum of agreement describing revisions made to a previous version of a contract.

In accordance with one or more implementations, information included in the contract revision timeline user interface 502 can be used to generate a report describing differences between a revised contract and a previous version of the revised contract. For instance, the contract management service can export data from the contract storage module 112, as displayed in the user interface 502, to generate textual descriptions of changes made between versions of a contract indicated by blocks 506(1) and 506(2), and so forth. In accordance with one or more implementations, display of the contract revision timeline user interface 502 can be performed by any suitable computing device, such as computing device 102 or client device 122 of FIG. 1.

Thus, the techniques described herein provide a comprehensive and intuitive overview of historical revisions made to a contract in a manner that is readily retrievable and indicates the exact information provided to contractual parties at the time of signing.

Example Procedures

The following discussion describes techniques that may be implemented utilizing the previously described systems and devices. Aspects of each of the procedures may be implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-5.

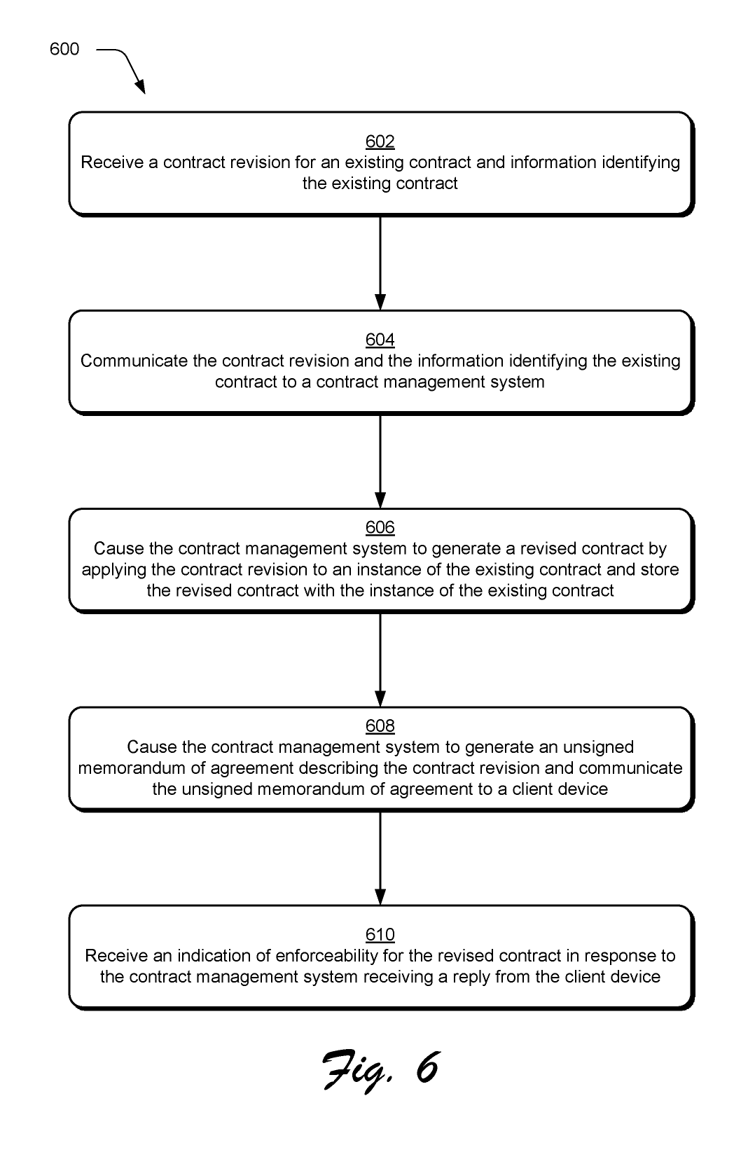

FIG. 6 depicts a procedure 600 in an example implementation of revision tracking and storage for contract renewals. A contract revision for an existing contract is received with information identifying the existing contract (block 602). The computing device 102, for instance, receives contract revision 106 from an input device of the computing device 102. Alternatively, the computing device 102 receives contract revision 106 from a different computing device, such as via network 128.

The received contract revision includes at least one of a new value for an existing contract field, a field to add to the existing contract, or a field to delete from the existing contract. For instance, the received contract revision can include at least one of contract revision values 310, contract additions 320, or contract deletions 322 of FIG. 3. The received contract revision additionally includes information identifying the existing contract. For instance, the contract revision 106 includes information specifying a contract identifier 304, a contract revision date 306, and two or more parties to the existing contract 308, as illustrated in FIG. 3.

In response to receiving the contract revision and information identifying the existing contract, the contract revision and information describing the existing contract are communicated to a contract management system (block 604). The computing device 102, for instance, communicates the contract revision 106 with associated information identifying the existing contract to contract management system 104 of FIG. 1. The contract management system is configured to use the information identifying the existing contract to locate the existing contract in a storage location. For instance, contract management system 104 is configured to locate contract 114 from contract storage module 112.

The contract management system is then caused to generate a revised contract and store the revised contract with the instance of the existing contract (block 606). Generating the revised contract is performed by applying the contract revision to an instance of the existing contract. For instance, the contract management system 104 generates revised contract 116 and stores the revised contract 116 in the contract storage module 112. An example revised contract is generated as having revised portions visually distinguished from unaltered portions, as illustrated in the revised contract 404 of FIG. 4.

The contract management system is additionally caused to generate an unsigned memorandum of agreement describing the contract revision as applied to the revised contract and communicate the unsigned memorandum of agreement to a signing party (block 608). For example, the contract management system is caused to generate unsigned MOA 120 and communicate the unsigned MOA 120 to a signing party at client device 122. The generated unsigned memorandum of agreement succinctly describes revisions to the existing contract, as illustrated in the example unsigned memorandum of agreement 302 of FIG. 3.

In response to the contract management system receiving a reply from the signing party at client device 122, an indication of enforceability for the revised contract is received (block 610). For example, in response to the client device 122 returning the signed MOA 126 to the contract management system, an indication that the revised contract 116 has become enforceable is received. Conversely, in the absence of the contract management system 104 receiving the signed MOA 126 or if the contract management system 104 receives a reply with a modified unsigned version of the MOA 120, an indication is received that the revised contract 116 is unenforceable. For instance, when the contract management system 104 receives a reply with a modified unsigned version of the MOA 120, the contract management system 104 treats the modified unsigned version of the MOA 120 as a new contract revision and returns to processing operations beginning at block 602.

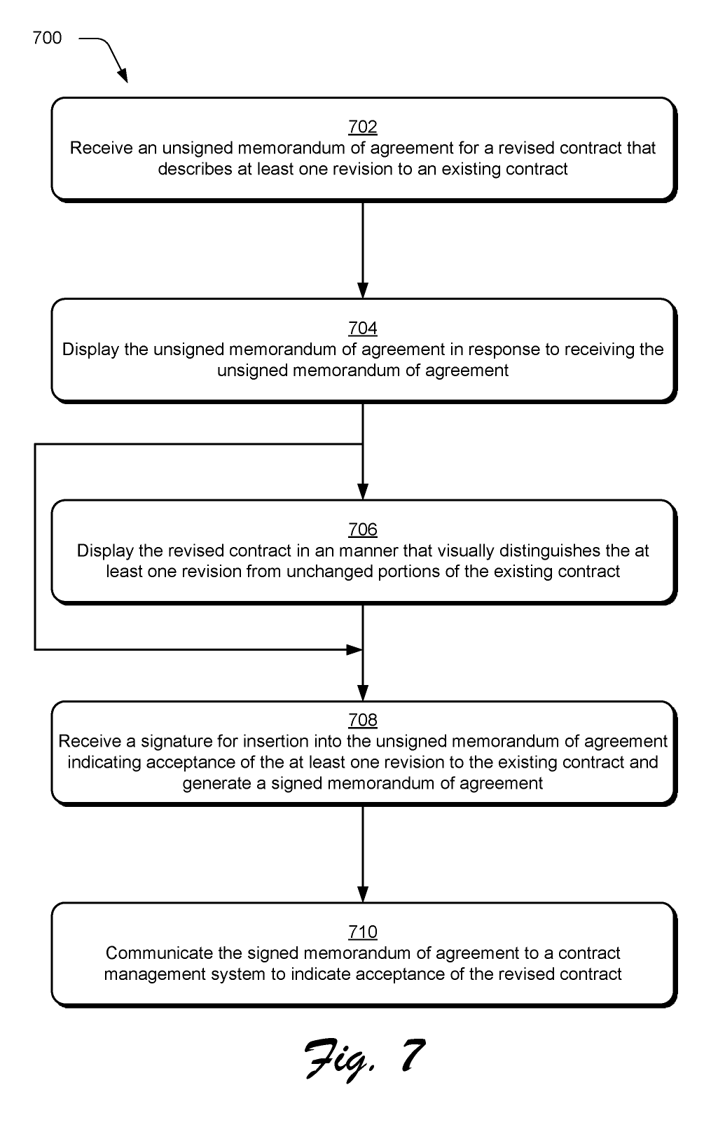

FIG. 7 depicts a procedure 700 in an example implementation of revision tracking and storage for contract renewals. An unsigned memorandum of agreement for a revised contract is received, which describes at least one revision to an existing contract (block 702). The client device 122, for example, receives the unsigned MOA 120 from the content management system 104. The unsigned MOA 120 describes revisions made to existing contract 114 in order to generate revised contract 116, such as illustrated in the example unsigned memorandum of agreement 302 of FIG. 3.

In response to receiving the unsigned memorandum of agreement, the unsigned memorandum of agreement is displayed (block 704). For example the contract review module 124 displays the received unsigned MOA 120 at a display device of client device 122. The unsigned memorandum of agreement succinctly describes revisions to the existing contract, and thus conveniently displays to a signing party changes to an existing contract, as illustrated in the example unsigned memorandum of agreement 302 of FIG. 3.

In addition to displaying the unsigned memorandum of agreement, the revised contract is displayed in a manner that visually distinguishes the at least one revision from unchanged portions of the existing contract (block 706). This display of the revised contract is optional, as indicated by the arrow circumventing block 706. In accordance with one or more implementations, display of the revised contract is initiated by user input to a selectable icon in the unsinged memorandum of agreement, such as icon 324 of FIG. 3. For example, displaying the revised contract is illustrated as the revised contract 404 of FIG. 4. In accordance with one or more implementations, display of the unsigned memorandum of agreement and the revised contract can be performed simultaneously, as illustrated in the example contract revision timeline 502 of FIG. 5.

Next, a signature is received for insertion into the unsigned memorandum of agreement indicating acceptance of the at least one revision to the existing contract and a signed memorandum of agreement is generated (block 708). For example, a signature is received in column 318 of the table of contract revision values 310, as illustrated in FIG. 3. Additionally or alternatively, a signature is received in one or more of contract additions 320 or contract deletions 322, as illustrated in FIG. 3. The received signature is inserted into the unsigned memorandum of agreement to generate a signed memorandum of agreement, such as signed MOA 126 illustrated in FIG. 1.

In response to generating the signed memorandum of agreement, the signed memorandum of agreement is communicated to a contract management system to indicate acceptance of the revised contract (block 710). For instance, the signed MOA 126 of FIG. 1 is communicated via network 128 to contract management system 104. Communicating the signed memorandum of agreement to the contract management system constitutes communicating acceptance of the revised contract to a drafting party, thereby making the revised contract enforceable.

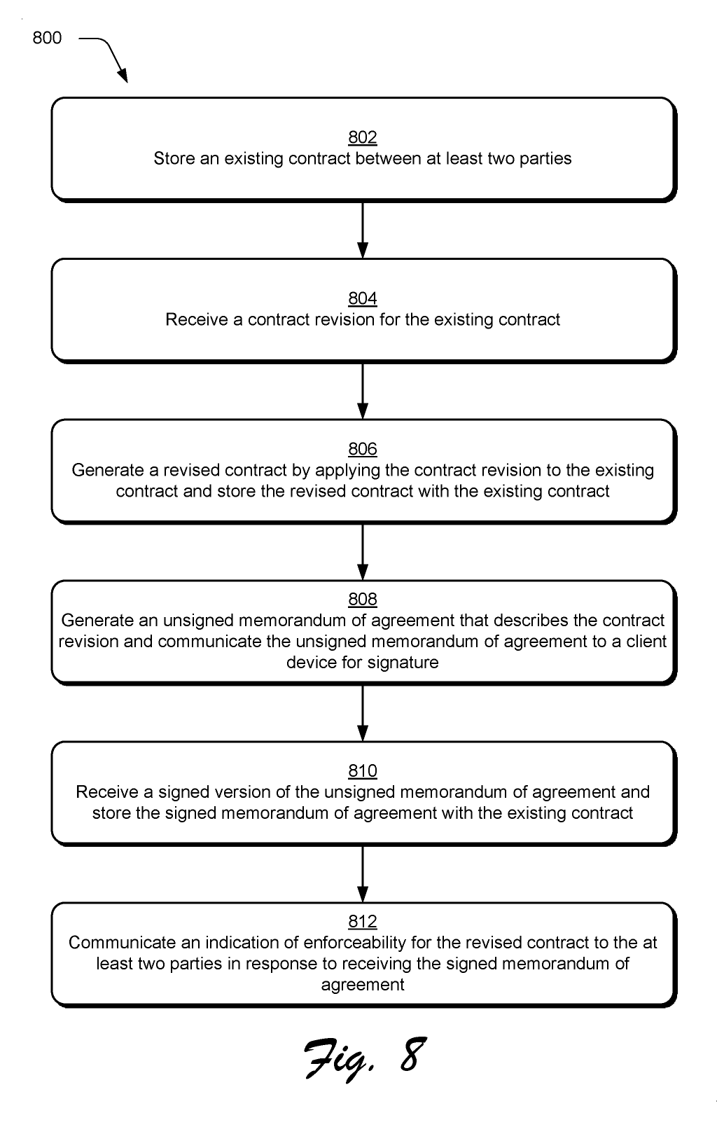

FIG. 8 depicts a procedure 800 in an example implementation of revision tracking and storage for contract renewals. An existing contract between at least two parties is stored (block 802). For example, an existing contract 114 is stored in contract storage module 112 of contract management system 104 in memory of computing device 102.

A contract revision for the existing contract is then received (block 804). For example, contract revision 106 is received from a drafting party at the contract management system 104. The received contract revision includes at least one of a new value for an existing contract field, a field to add to the existing contract, or a field to delete from the existing contract. For instance, the received contract revision can include at least one of contract revision values 310, contract additions 320, or contract deletions 322 of FIG. 3. The received contract revision additionally includes information identifying the existing contract. For instance, the contract revision 106 includes information specifying a contract identifier 304, a contract revision date 306, and two or more parties to the existing contract 308, as illustrated in FIG. 3.

In response to receiving the contract revision, a revised contract is generated by applying the contract revision to the existing contract and the revised contract is stored with the existing contract (block 806). For example, contract update module 108 generates revised contract 116 by applying the contract revision 106 to the contract 114. After generating the revised contract 116, the contract storage module 112 associates the revised contract with the existing contract 114 and stores them together in memory of the computing device 102. By associating the revised contract with the existing contract, the contract management system 104 enables retrieval of the existing contract when searching for the revised contract, and vice versa. An example revised contract is generated as having revised portions visually distinguished from unaltered portions, as illustrated in the revised contract 404 of FIG. 4.

In response to generating the revised contract, an unsigned memorandum of agreement that describes the received contract revision is generated and communicated to a client device for signature (block 808). For example, the contract update module 108 generates unsigned MOA 120 and communicates the unsigned MOA 120 to client device 122 for signature. The generated unsigned memorandum of agreement succinctly describes revisions to the existing contract 114, as illustrated in the example unsigned memorandum of agreement 302 of FIG. 3.

Next, a signed version of the unsigned memorandum of agreement is received and stored with the existing contract (block 810). For example, the contract management system 104 receives signed MOA 126 from the client device 122. The signed MOA 126 is associated with both the contract 114 and the revised contract 116 and stored as memorandum of agreement 118 by contract storage module 112 in memory of the computing device 102.

An indication of enforceability of the revised contract is then communicated to the at least two parties in response to receiving the signed memorandum of agreement (block 812). For example, in response to the client device 122 returning the signed MOA 126 to the contract management system, an indication that the revised contract 116 has become enforceable is communicated to the computing device 102 and the client device 122. Thus, the contract management system 104 is configured to facilitate contract revisions, store information describing the revisions in a manner convenient for retrieval, and communicate to all involved parties whether the revised contract is enforceable.

Example System and Device

FIG. 9 illustrates an example system generally at 900 that includes an example computing device 902 that is representative of one or more computing systems and/or devices that may implement the various techniques described herein. This is illustrated through inclusion of the contract management system 104. The computing device 902 may be, for example, a server of a service provider, a device associated with a client (e.g., a client device), an on-chip system, and/or any other suitable computing device or computing system.

The example computing device 902 as illustrated includes a processing system 904, one or more computer-readable media 906, and one or more I/O interface 908 that are communicatively coupled, one to another. Although not shown, the computing device 902 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware element 910 that may be configured as processors, functional blocks, and so forth. This may include implementation in hardware as an application specific integrated circuit or other logic device formed using one or more semiconductors. The hardware elements 910 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 906 is illustrated as including memory/storage 912. The memory/storage 912 represents memory/storage capacity associated with one or more computer-readable media. The memory/storage component 912 may include volatile media (such as random access memory (RAM)) and/or nonvolatile media (such as read only memory (ROM), Flash memory, optical disks, magnetic disks, and so forth). The memory/storage component 912 may include fixed media (e.g., RAM, ROM, a fixed hard drive, and so on) as well as removable media (e.g., Flash memory, a removable hard drive, an optical disc, and so forth). The computer-readable media 906 may be configured in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described systems, modules, and techniques may be stored on or transmitted across some form of computer-readable media. The computer-readable media may include a variety of media that may be accessed by the computing device 902. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 902, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 910. The computing device 902 may be configured to implement particular instructions and/or functions corresponding to the software and/or hardware modules. Accordingly, implementation of a module that is executable by the computing device 902 as software may be achieved at least partially in hardware, e.g., through use of computer-readable storage media and/or hardware elements 910 of the processing system 904. The instructions and/or functions may be executable/operable by one or more articles of manufacture (for example, one or more computing devices 902 and/or processing systems 904) to implement techniques, modules, and examples described herein.

The techniques described herein may be supported by various configurations of the computing device 902 and are not limited to the specific examples of the techniques described herein. This functionality may also be implemented all or in part through use of a distributed system, such as over a “cloud” 914 via a platform 916 as described below.

The cloud 914 includes and/or is representative of a platform 916 for resources 918. The platform 916 abstracts underlying functionality of hardware (e.g., servers) and software resources of the cloud 914. The resources 918 may include applications and/or data that can be utilized while computer processing is executed on servers that are remote from the computing device 902. Resources 918 can also include services provided over the Internet and/or through a subscriber network, such as a cellular or Wi-Fi network.

The platform 916 may abstract resources and functions to connect the computing device 902 with other computing devices. The platform 916 may also serve to abstract scaling of resources to provide a corresponding level of scale to encountered demand for the resources 918 that are implemented via the platform 916. Accordingly, in an interconnected device embodiment, implementation of functionality described herein may be distributed throughout the system 900. For example, the functionality may be implemented in part on the computing device 902 as well as via the platform 916 that abstracts the functionality of the cloud 914.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital medium environment to track and store revisions for contract renewals, a contract management system comprising:
a contract storage module implemented at least partially in hardware of a computing device to store a contract;
a contract update module implemented at least partially in hardware of the computing device to receive a contract revision for the stored contract, automatically generate a revised contract by applying the contract revision to the stored contract, and display a field of the revised contract that is different from a corresponding field in the stored contract in a manner that is visually distinguishable from other fields of the revised contract; and
a contract signature module implemented at least partially in hardware of the computing device to automatically generate an unsigned memorandum of agreement that describes the contract revision and communicate the unsigned memorandum of agreement to a client device for signature.

2. The system as described in claim 1, wherein the contract revision for the stored contract is received from a device other than the client device.

3. The system as described in claim 1, wherein the contract revision indicates a named field that corresponds to the mapped portion of the stored contract and a replacement value for the named field to be included in the revised contract.

4. The system as described in claim 1, wherein the contract revision indicates at least one of a field to be added to the stored contract to generate the revised contract or a field to be removed from the stored contract to generate the revised contract.

5. The system as described in claim 1, wherein the display of the field that was altered from the application of the contract revision to the stored contract is displayed in a different font, different color, or different size from other fields of the revised contract.

6. The system as described in claim 1, wherein the stored contract comprises an altered version of an original contract.

7. The system as described in claim 1, wherein the unsigned memorandum of agreement includes a description of a contract field to be altered by the contract revision, an old value of the contract field as included in the stored contract, a new value of the contract field as included in the revised contract, and a portion for entry of a signature indicating acceptance of the new value of the contract field.

8. The system as described in claim 1, wherein the contract signature module is configured to communicate the revised contract to the client device with the unsigned memorandum of agreement.

9. The system as described in claim 1, wherein the contract storage module is configured to associate the stored contract with the contract revision, the revised contract, the unsinged memorandum of agreement, and the signed version of the unsigned memorandum of agreement as associated documents and return the associated documents in response to receiving a request for one of the associated documents.

10. The system as described in claim 1, wherein the contract update module is further configured to automatically generate a new unsigned memorandum of agreement and a new revised contract upon receiving a reply from the client device that includes a proposed modification to the contract revision by applying the proposed modification to the contract revision to the stored contract.

11. In a digital medium environment to track and store revisions for contract renewals, a method implemented by a computing device, the method comprising:
receiving, by the computing device, a contract revision for an existing contract and information identifying the existing contract;
causing, by the computing device, a contract management system to generate a revised contract by applying the contract revision to an instance of the existing contract and store the revised contract as being linked to the instance of the existing contract; and
causing, by the computing device, the contract management system to generate an unsinged memorandum of agreement describing the contract revision and communicate the unsinged memorandum of agreement to a client device.

12. The method as described in claim 11, wherein the information identifying the existing contract comprises at least one of a contract name, a contract serial number, an effective date of the existing contract, or a list of parties to the contract.

13. The method as described in claim 11, wherein the instance of the existing contract is stored in memory of the contract management system prior to the computing device communicating the contract revision and the information identifying the existing contract to the contract management system.

14. The method as described in claim 11, the method further comprising communicating, by the computing device, the existing contract to the contract management system with the device, the contract revision and the information identifying the existing contract and causing the contract management system to store the instance of the existing contract.

15. The method as described in claim 11, the method further comprising receiving, by the computing device, an indication of enforceability for the revised contract in response to the contract management system receiving a reply from the client device.

16. The method as described in claim 15, wherein the received indication of enforceability indicates that the revised contract is enforceable in response to the contract management system receiving a signed version of the unsigned memorandum of agreement from the client device, and otherwise indicates that the revised contract is unenforceable.

17. A computer-readable storage media device comprising instructions stored thereon that, responsive to execution by at least one processing device, causes the at least one processing device to perform operations comprising:
receiving an unsigned memorandum of agreement for a revised contract that describes a revision made to an existing contract in order to generate the revised contract;
receiving a signature for insertion into the unsigned memorandum of agreement and generating a signed memorandum of agreement by inserting the signature into the unsigned memorandum of agreement, the signed memorandum of agreement indicating acceptance of the revision made to the existing contract in order to generate the revised contract; and
causing a contract management system to generate the revised contract by communicating the signed memorandum of agreement to the contract management system.

18. The computer-readable storage media device of claim 17, the operations further comprising receiving the revised contract and displaying the revised contract in a manner that visually distinguishes the revision made to the existing contract from a portion of the revised contract that remains unchanged from the existing contract.

19. The computer-readable storage media device of claim 18, wherein the signed memorandum of agreement and the revised contract are displayed simultaneously in a timeline user interface that visually indicates historical revisions to the existing contract.

20. The computer-readable storage media device of claim 19, wherein the timeline user interface is navigable via user input to view past versions of the existing contract and to generate a report describing differences among the past versions of the existing contract.
